(19) United States
(12) Patent Application Publication
(10) Pub. No.: US 2024/0020621 A1
(43) Pub. Date: Jan. 18, 2024

(54) DELIVERY SUPPORT DEVICE, SYSTEM, AND DELIVERY SUPPORT METHOD

(71) Applicant: TOYOTA JIDOSHA KABUSHIKI KAISHA, Aichi-ken (JP)

(72) Inventors: Yoshikazu JIKUHARA, Miyoshi-shi (JP); Jun HIOKI, Nagakute-shi (JP); Kaori YAMADA, Nagakute-shi (JP); Maiko WATANABE, Nagoya-shi (JP); Yuki KUWAYAMA, Yokohama-shi (JP); Shunya MARUTA, Tokyo (JP); Yo OKUMURA, Tokyo (JP)

(21) Appl. No.: 18/348,349

(22) Filed: Jul. 7, 2023

(30) Foreign Application Priority Data
Jul. 12, 2022 (JP) 2022-112047

(51) Int. Cl. G06Q 10/0832; G06Q 10/0835

(52) U.S. Cl. CPC G06Q 10/0832; G06Q 10/08355

(57) ABSTRACT

The delivery support device supports delivery of one or more articles. The delivery support device includes a control unit that acquires temperature data indicating a temperature of each article for each of the one or more articles, and adjusts a delivery order of the one or more articles according to the temperature indicated by the acquired temperature data.

### CROSS-REFERENCE TO RELATED APPLICATION

This application claims priority to Japanese Patent Application No. 2022-112047 filed on Jul. 12, 2022, incorporated herein by reference in its entirety.

### BACKGROUND

### 1. Technical Field

The present disclosure relates to a delivery support device, a system, and a delivery support method.

### 2. Description of Related Art

US Patent Application Publication No. 2015/0379468 discloses a technique for delivering a package to a plurality of delivery destinations in two stages by using an on-road vehicle and an autonomous delivery vehicle.

### SUMMARY

When a temperature increases during transportation of an article such as a frozen food product, the article may be thawed, for example, and the quality may be deteriorated.

An object of the present disclosure is to be able to suppress quality deterioration of an article during transportation.

A delivery support device according to the present disclosure is
a delivery support device that supports delivery of one or more articles,
in which the delivery support device includes a control unit that acquires temperature data indicating a temperature per article for each of the one or more articles, and adjusts a delivery order of the one or more articles in accordance with the temperature indicated by the acquired temperature data.

A delivery support method according to the present disclosure is a delivery support method that supports delivery of one or more articles, in which the delivery support method includes causing a control unit to acquire temperature data indicating a temperature per article for each of the one or more articles, and to adjust a delivery order of the one or more articles in accordance with the temperature indicated by the acquired temperature data.

According to the present disclosure, deterioration in quality of an article during transportation is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to an embodiment of the present disclosure;

FIG. 2 is a diagram illustrating an example of delivery by a system according to an embodiment of the present disclosure;

FIG. 3 is a block diagram illustrating a configuration of a delivery support device according to an embodiment of the present disclosure;

FIG. 4 is a block diagram illustrating a configuration of a second vehicle according to an embodiment of the present disclosure;

FIG. 5 is a flowchart illustrating an operation of a delivery support device according to an embodiment of the present disclosure;

FIG. 6 is a diagram illustrating a process flow of adjusting a delivery order according to an embodiment of the present disclosure;

FIG. 7 is a diagram illustrating a processing flow of determining an operation route according to an embodiment of the present disclosure;

FIG. 8 is a flowchart illustrating another operation of the delivery support device according to the embodiment of the present disclosure.

### DETAILED DESCRIPTION OF EMBODIMENTS

Hereinafter, an embodiment of the present disclosure will be described with reference to the drawings.

In each drawing, the same or corresponding portions are denoted by the same reference signs. In the description of the present embodiment, description of the same or corresponding components will be appropriately omitted or simplified.

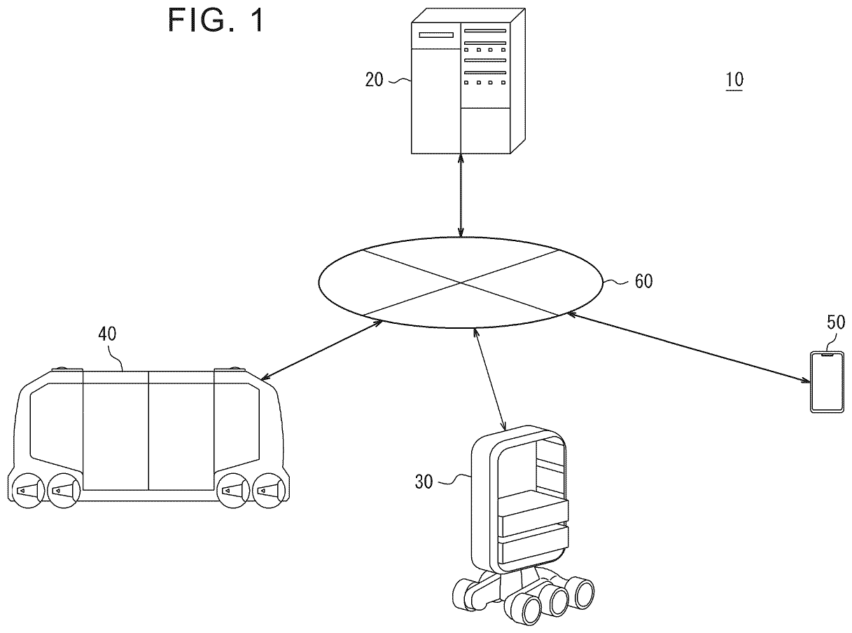

The configuration of a system 10 according to the present embodiment will be described with reference to FIG. 1.

The system 10 according to the present embodiment includes at least one delivery support device 20, at least one second vehicle 30, at least one first vehicle 40, and at least one terminal device 50. The delivery support device 20 is capable of communicating with the second vehicle 30, the first vehicle 40, and the terminal device 50 via the network 60.

The delivery support device 20 is installed in a facility such as a data center and is operated by an operator who manages the system 10. The business operator is, for example, a delivery business operator that stores goods such as baggage from a customer and delivers them to a delivery destination designated as a destination. The delivery support device 20 is a computer such as a server belonging to a cloud computing system or other computing system.

The first vehicle 40 is any type of vehicle, such as a gasoline-powered vehicle, a diesel-powered vehicle, a hydrogen-powered vehicle, hybrid electric vehicle (HEV), plug-in hybrid electric vehicle (PHEV), battery electric vehicle (BEV), or fuel cell electric vehicle (FCEV). The first vehicles 40 are autonomous vehicle (AV) in this embodiment, but may be driven by a driver or may be automated in driving at any level. The level of automation is, for example, any of level 1 to level 5 in the level division of Society of Automotive Engineers (SAE). The first vehicle 40 may be a Mobility as a Service (MaaS) dedicated vehicle.

In this embodiment, the first vehicle 40 transports one or more articles. One or more articles include those that require temperature control to maintain quality. An item requiring temperature control to maintain quality is, for example, a frozen food. The first vehicle 40 is provided with a temperature sensor TS1 that detects a temperature of an article mounted on the first vehicle 40. The first vehicle 40 loads the goods sent from the sender and transports the goods to the intermediate delivery point. In the present embodiment, the intermediate delivery point is a place where an article is delivered from the first vehicle 40 to the second vehicle 30. Specifically, the intermediate delivery point is a standby place of the second vehicle 30 in the apartment house. Alternatively, the intermediate delivery point is an intermediate collection and delivery station that temporarily retains the item to be delivered. At the intermediate delivery point, the article is delivered from the first vehicle 40 to the second vehicle 30.

The second vehicle 30 is a logistics robot that autonomously delivers articles. The second vehicle 30 includes an arbitrary delivery vehicle that moves between the via points by autonomous driving. The second vehicle 30 may be, for example, a humanoid robot. Alternatively, the second vehicle 30 may be any unmanned aerial vehicle flying autonomously, for example a drone. The second vehicle 30 may be positioned as a second vehicle relative to the first vehicle 40. The second vehicle 30 may be, for example, an in-hall logistics robot installed in an apartment house such as a condominium or an apartment house and specializing in delivering goods to each house (each door) in the apartment house.

The one or more terminal devices 50 may be held by one or more users, or may be installed at any location, such as at the user's home, and used by the user. The terminal device 50 is, for example, a mobile device such as a mobile phone, a smart phone, or a tablet, or a personal computer (PC). In the present embodiment, the user is the addressee of the article, but the user may be the sender of the article. Alternatively, the user may be an administrator of the system 10. When the user is an administrator of the system 10, the terminal device 50 may be installed in a management room of the system 10 and used by the one or more users. Alternatively, the terminal device 50 installed in the management room may be shared by two or more users.

In the present embodiment, the second vehicle 30 loads the article delivered from the first vehicle 40 and autonomously delivers the article to the delivery destination of each article. In the present embodiment, the delivery destination is a door of the addressee for each article. When the second vehicle 30 arrives at the delivery destination of an article, it delivers the article to the addressee of the article.

Network 60 includes the Internet, at least one wide area network (WAN), at least one metropolitan area network (MAN), or any combination thereof. The network 60 may include at least one wireless network, at least one optical network, or any combination thereof. The wireless network is, for example, an ad hoc network, a cellular network, a wireless local area network (LAN, a satellite communication network, or a terrestrial microwave network.

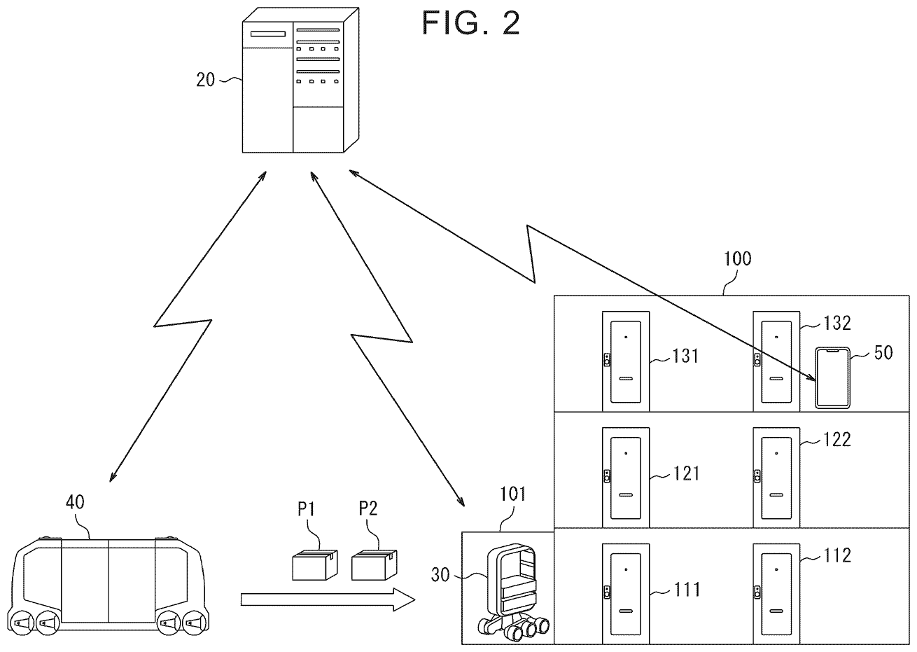

The outline of the present embodiment will be described with reference to FIGS. 1 and 2.

In the system shown in FIG. 1, a delivery support device 20 that assists in the delivery of one or more articles obtains a temperature data D1 for each of the one or more articles. The temperature data D1 is data indicating the temperature of each article. The delivery support device 20 adjusts the delivery order of the one or more articles according to the temperature indicated by the acquired temperature data D1.

According to the present embodiment, it is possible to determine the delivery order of the articles based on the information indicating the temperature of each article. Thus, for example, items requiring temperature control to maintain quality, such as fresh or frozen foods, can be delivered in preference to other items. Therefore, deterioration in quality of the article during transportation is suppressed.

In the present embodiment, in the system 10, one or more articles are delivered to a house (door) in an apartment house (apartment house, condominium, or the like). Referring to FIG. 2, the basic steps of the article P1 issued by the resident of the house 132 as the addressee and the article P2 issued by the resident of the house 111 as the addressee in the multiple apartment house 100 will be described.

In FIG. 2, the apartment house 100 includes a plurality of houses 111,112,121,122,131,132. Further, in the facility of the apartment house 100, a second vehicle 30 that delivers goods to each residence is permanently installed. The apartment house 100 includes a standby space 101 in which the second vehicle 30 stands by. Although one second vehicle 30 is illustrated in FIG. 2, the number of the second vehicles 30 is not limited to one, and a plurality of second vehicle 30i to 30n may be permanently installed.

In this embodiment, the delivery process of delivering one or more articles includes a first delivery process in which one or more articles are transported by the first vehicle 40 and a second delivery process in which one or more articles are delivered from the first vehicle 40 to a second vehicle 30 separate from the first vehicle 40 and transported by the second vehicle 30. More specifically, the first delivery process is a process from when one or more articles are mounted on the first vehicle 40 to when they are transported by the first vehicle 40 to an intermediate delivery point and delivered from the first vehicle 40 to the second vehicle 30 at the intermediate delivery point. The second delivery process is a process from when one or more articles are delivered to the second vehicle 30 to when they are transported by the second vehicle 30 to the respective destinations of the one or more articles and delivered to the respective addressees of the one or more articles.

The first vehicle 40 loads one or more articles based on a command from the delivery support device 20, and moves to the apartment house 100. The one or more articles include an article P1, article P2. In addition to the items to be delivered to the apartment house 100, the first vehicle 40 may be loaded with items to another house to be delivered collectively.

The first vehicle 40 arrives in the standby space 101 of the apartment house 100, and delivers one or more articles including the article P1, article P2 to the second vehicle waiting in the standby space 101. In the present embodiment, the standby space 101 in which the second vehicle 30 stands by serves as an intermediate delivery point. In the present embodiment, the intermediate delivery point is a place where each item is delivered from the first vehicle 40 to the second vehicle 30. Delivery of each article is performed using a driving unit included in the first vehicle 40, a driving unit 37 included in the second vehicle 30, or both. The driving unit included in the first vehicle 40 or the driving unit 37 included in the second vehicle 30 includes at least one of an arm mechanism driven by a motor and a slide mechanism capable of linearly sliding an article. Alternatively, the delivery of each article may be performed by an operator who has ridden the first vehicle 40.

The delivery support device 20 transmits operation route information indicating an operation route when transporting each article to the second vehicle 30. Specifically, the operation route is a route from the standby space 101 to the destination of the article P1 and the destination of the article P2. In the present embodiment, the house 132 is registered as the destination of the article P1 in the article P1 issued with the resident of the house 132 as the addressee. Similarly, in the article P2 issued with the resident of the house 111 as the addressee, the house 111 is registered as the address of the article P2. In the present embodiment, the operation route is a route from the standby space 101 in which the second vehicle 30 is waiting through the house 132 that is the destination of the article P1 and the house 111 that is the destination of the article P2. Alternatively, when the second vehicle 30 is in a place other than the standby space 101, the operation route may be, for example, a route from a point where the second vehicle 30 is located to a destination for each item.

The second vehicle 30 moves in the apartment house 100 in a self-propelled manner, and transports each item according to an operation route indicated by the operation route information transmitted from the delivery support device 20. A method of determining an operation route by the delivery support device 20 will be described later. The second vehicle 30 transports the article P1 to the house 132 in the apartment house 100 according to the operation route indicated by the operation route information transmitted from the delivery support device 20. The second vehicle 30 transports the article P2 to the house 111 in the apartment house 100 according to the operation route indicated by the operation route information transmitted from the delivery support device 20. The delivery method of the article by the second vehicle 30 may be a so-called placement in which the article is placed in front of the residence of the destination, but when the second vehicle 30 is provided with the output unit 35 to be described later, it is desirable to inform the destination person of the article by voice or the like to deliver the article directly to the destination person. In this way, the article P1, article P2 is delivered to the respective addressee.

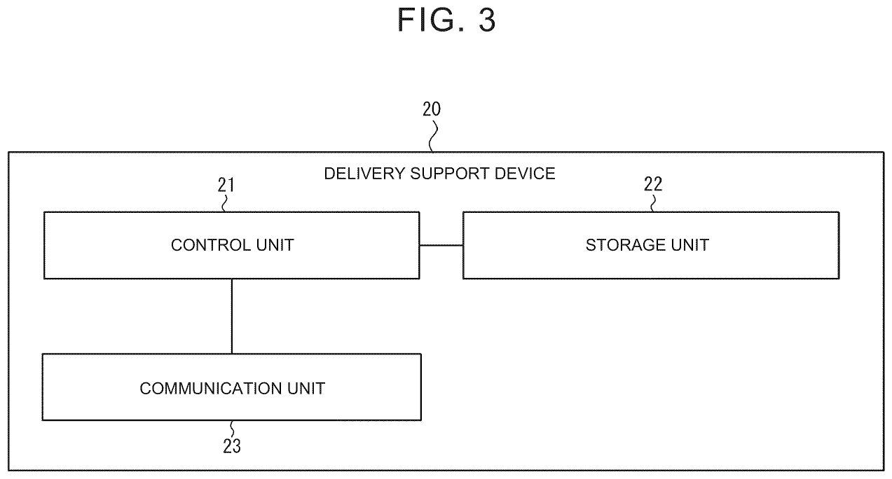

A configuration of the delivery support device 20 according to the present embodiment will be described with reference to FIG. 3.

The delivery support device 20 includes a control unit 21, a storage unit 22, and a communication unit 23.

The control unit 21 includes at least one processor, at least one programmable circuit, at least one dedicated circuit, or any combination thereof. A processor is a general-purpose processor such as central processing unit (CPU) or graphics processing unit (GPU), or a special-purpose processor specialized for a particular process. The programmable circuitry is, for example, field programmable gate array (FPGA). The dedicated circuitry is, for example, application specific integrated circuit (ASIC). The control unit 21 executes processing related to the operation of the delivery support device 20 while controlling each unit of the delivery support device 20.

The storage unit 22 includes at least one semiconductor memory, at least one magnetic memory, at least one optical memory, or a combination of at least two of them. Semiconductor memories are, for example, random access memory (RAM) or read only memory (ROM). RAM is, for example, static random access memory (SRAM) or dynamic random access memory (DRAM). ROM is, for example, electrically erasable programmable read only memory (EEPROM). The storage unit 22 functions as, for example, a main storage device, an auxiliary storage device, or a cache memory. The storage unit 22 stores data used for the operation of the delivery support device 20 and data obtained by the operation of the delivery support device 20.

The communication unit 23 includes at least one communication interface. The communication interface is, for example, a LAN interface. The communication unit 23 communicates with one or more second vehicles 30, one or more first vehicles 40, and one or more terminal devices 50. The communication unit 23 receives data used for the operation of the delivery support device 20 and transmits data obtained by the operation of the delivery support device 20.

The function of the delivery support device 20 is realized by executing the program according to the present embodiment by a processor serving as the control unit 21. That is, the functions of the delivery support device 20 are realized by software. The program causes the computer to execute the operation of the delivery support device 20, thereby causing the computer to function as the delivery support device 20. That is, the computer functions as the delivery support device 20 by executing the operation of the delivery support device 20 in accordance with the program.

The program can be stored in a non-transitory computer-readable medium. The non-transitory computer-readable medium is, for example, a flash memory, a magnetic recording device, an optical disc, an opto-magnetic recording medium, or a ROM. Distribution of the program is performed, for example, by selling, transferring, or lending a portable medium such as a Secure Digital (SD) card, digital versatile disc (DVD), or compact disc read only memory (CD-ROM storing the program. The program may be stored in the storage of the server and transferred from the server to other computers to distribute the program. The program may be provided as a program product.

The computer temporarily stores the program stored in the portable medium or the program transferred from the server in the main storage device, for example. The computer then causes the processor to read the program stored in the main storage device, and causes the processor to execute processes in accordance with the read program. The computer may read the program directly from the portable medium and execute processes in accordance with the program. The computer may execute the processes in accordance with the received program each time the program is transferred from the server to the computer. The process may be executed by a so-called application service provider (ASP type service that realizes a function only by an execution instruction and a result-acquisition, without transferring a program from a server to a computer. The program includes information that is used for processing by electronic computers and equivalent to a program. For example, data that is not a direct command to a computer but has the property of defining the processing of the computer corresponds to the “data equivalent to a program”.

Some or all of the functions of the delivery support device 20 may be realized by a processor, a programmable circuit, or a dedicated circuit as the control unit 21. That is, some or all of the functions of the delivery support device 20 may be realized by hardware.

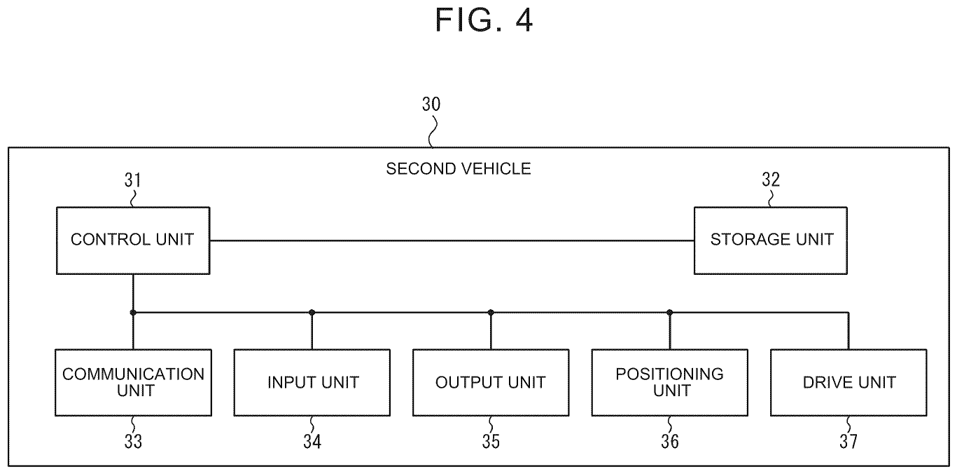

A configuration of the second vehicle 30 according to the embodiment of the present disclosure will be described with reference to FIG. 4.

The second vehicle 30 includes a control unit 31, a storage unit 32, a communication unit 33, an input unit 34, an output unit 35, a positioning unit 36, and a driving unit 37.

The control unit 31 includes at least one processor, at least one programmable circuit, at least one dedicated circuit, at least one electronic control unit (ECU), or any combination thereof. The processor is a general-purpose processor such as a CPU or a GPU, or a dedicated processor specialized for a specific process. The programmable circuit is, for example, an FPGA. The dedicated circuit is, for example, an ASIC. The control unit 31 executes processing related to the operation of the second vehicle while controlling each functional component of the second vehicle 30.

The storage unit 32 includes at least one semiconductor memory, at least one magnetic memory, at least one optical memory, or a combination of at least two of them. The semiconductor memory is, for example, a RAM or a ROM. The RAM is, for example, a static random access memory (SRAM) or a dynamic random access memory (DRAM). The ROM is, for example, an EEPROM. The storage unit 32 functions as, for example, a main storage device, an auxiliary storage device, or a cache memory. The storage unit 32 stores data used for the operation of the second vehicle 30 and data obtained by the operation of the second vehicle 30.

The communication unit 33 includes at least one communication interface. The communication interface is, for example, an interface compliant with a mobile communication standard such as Long Term Evolution (LTE), 4th generation standard, or 5th generation standard, an interface compliant with near field communication such as Bluetooth (registered trademark), or a LAN interface. The communication unit 33 receives data used for the operation of the second vehicle 30 and transmits data obtained by the operation of the second vehicle 30.

The input unit 34 includes at least one input interface. The input interface is, for example, a physical key, a capacitive key, a pointing device, a touch screen integrated with a display, or a microphone. The input unit 34 receives an operation of inputting data used for the operation of the second vehicle 30. Instead of being provided in the second vehicle 30, the input unit 34 may be connected to the second vehicle 30 as an external input device. As the connecting method, any method such as Universal Serial Bus (USB), High-Definition Multimedia Interface (HDMI (registered trademark), or Bluetooth (registered trademark) can be used. The input unit 34 includes means for inputting information to the second vehicle 30. The input unit 34 may include any means for acquiring information about the surroundings of the second vehicle 30. For example, the input unit 34 includes a temperature sensor TS2 that detects a temperature of an article mounted on the second vehicle 30. The temperature sensor TS2 may be capable of measuring a temperature around the second vehicle 30. The input unit 34 may include a voice recognition function as well as a voice information input unit. The input unit 34 may include any imaging module capable of imaging the periphery of the second vehicle 30. The imaging module may include a function of reading a display of a delivery destination attached to the article. The imaging module may include one or more cameras. Each camera is disposed at an appropriate position of the second vehicle 30 so as to be able to capture an image of the periphery of the second vehicle 30.

The output unit 35 includes at least one output interface. The output interface is, for example, a display or a speaker. Displays are, for example, liquid crystal display (LCD) or organic electro luminescence (EL) displays. The output unit 35 outputs data obtained by the operation of the second vehicle 30. Instead of being provided in the second vehicle 30, the output unit 35 may be connected to the second vehicle as an external output device. As a connection method, for example, any method such as USB, HDMI (registered trademark), or Bluetooth (registered trademark) can be used. The output unit 35 outputs the data received from the delivery support device 20, the data stored in the second vehicle 30, the data obtained by the operation of the second vehicle 30, and the like to the user, for example, by characters, images, or sounds.

The positioning unit 36 includes at least one global navigation satellite system (GNSS) receiver. GNSS is, for example, Global Positioning System (GPS), Quasi-Zenith Satellite System (QZSS), BeiDou, Global Navigation Satellite System (GLONASS), or Galileo. The positioning unit 36 measures the position of the second vehicle 30. The positioning unit 36 may constantly acquire the positional information of the second vehicle 30, or may periodically or non-periodically acquire the positional information.

The driving unit 37 includes a driving mechanism for moving and traveling of the second vehicle 30. Drive 37 also includes any drive mechanism that allows loading of articles on second vehicle 30, delivery of articles loaded on second vehicle 30 to the addressee, and unloading of articles loaded on second vehicle 30 to a designated location. For example, the driving unit 37 includes at least one of an arm mechanism driven by a motor and a slide mechanism capable of linearly sliding an article.

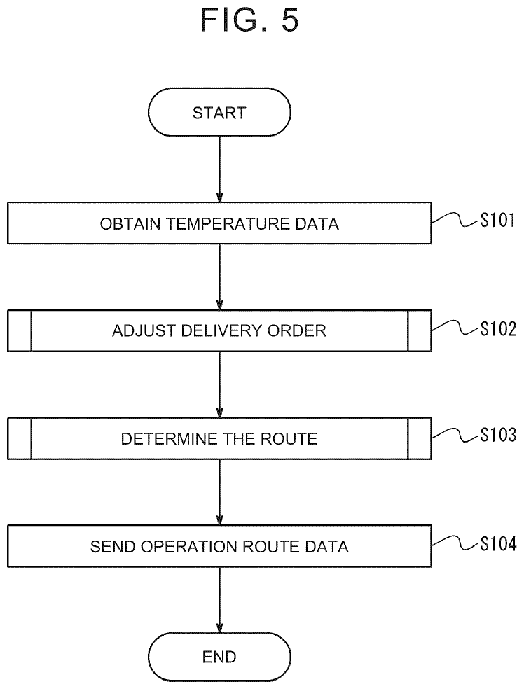

The operation of the delivery support device 20 according to the present embodiment will be described with reference to FIG. 5 to FIG. 7. This operation corresponds to the delivery support method according to the present embodiment.

In S101 of FIG. 5, the control unit 21 of the delivery support device 20 acquires temperature data D1 indicating the temperature of each article for each of the one or more articles. In this embodiment, the one or more articles are article P1, article P2. The control unit 21 acquires, as the temperature data D1, data indicating the temperature t1 of the article P1 and the temperature t2 of the article P2.

The temperature data D1 may be acquired by the delivery support device 20 by any means, but in the present embodiment, it is acquired by the following steps.

When the article P1 and the article P2, which are one or more articles delivered from the first vehicle 40, are loaded on the second vehicle 30, the temperature sensor TS2 provided as the input unit 34 of the second vehicle 30 detects the article P1 temperature t1 and the temperature t2 of the article P2. The second vehicle 30 transmits information indicating the value detected by the temperature sensor TS2 to the delivery support device 20 as a temperature data D1 via the communication unit 33. The control unit 21 of the delivery support device 20 receives the temperature data D1 transmitted from the second vehicles 30 via the communication unit 23. Alternatively, the control unit 21 of the delivery support device 20 may communicate with the temperature sensor TS2 via the communication unit 23, and directly receive the temperature data D1 transmitted from the temperature sensor TS2 from the temperature sensor TS2.

As a modification of the present embodiment, the temperature data D1 may be transmitted from the first vehicle 40. Specifically, when the article P1 and the article P2, which are one or more articles sent out from the sender, are loaded into the first vehicle 40, the temperature sensor TS1 provided in the first vehicle 40 detects the temperature t1 of the article P1 and the temperature t2 of the article P2. The first vehicle 40 transmits information indicating the value detected by the temperature sensor TS1 to the delivery support device as a temperature data D1. The control unit 21 of the delivery support device 20 receives the temperature data D1 transmitted from the first vehicles 40 via the communication unit 23.

In this way, the control unit 21 of the delivery support device 20 acquires temperature data D1 indicating the temperature of each article for each of the one or more articles. In the present embodiment, the control unit 21 of the delivery support device 20 acquires, as the temperature data D1, data indicating the temperature t1 of the article P1 and the temperature t2 of the article P2.

In S102 of FIG. 5, the control unit 21 of the delivery support device 20 adjusts the delivery order of one or more articles in accordance with the temperature indicated by the temperature data D1 acquired in S101. Specifically, the control unit 21 adjusts the delivery order of the article P1 and the article P2 in accordance with the temperature t1 of the article P1 and the temperature t2 of the article P2.

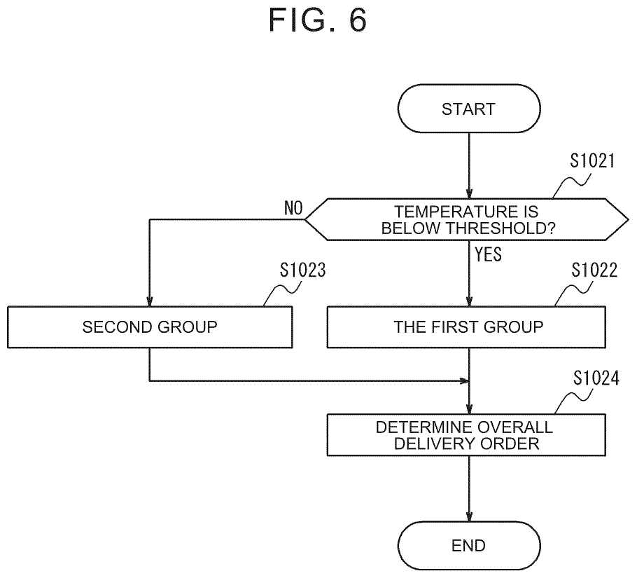

Referring to FIG. 6, a process of adjusting the delivery order in S102 of FIG. will be described.

In S1021 of FIG. 6, the control unit 21 of the delivery support device 20 compares the temperature indicated by the acquired temperature data D1 with the threshold Th for each of the one or more articles. Specifically, the control unit 21 compares the temperature t1 of the article P1 and the temperature t2 of the article P2 indicated by the temperature data D1 with the thresholds Th. In the present embodiment, the threshold Th is a predetermined temperature to the extent deemed to be required to prevent degradation in transportation. For example, Th of thresholds is set to −15° C., assuming that the frozen food is a product requiring thermal control.

In the present embodiment, it is assumed that the article P1 has a thermal t1 of −20° C. The control unit 21 determines that the thermal t1 of the article P1 is less than the threshold Th in S1021. If it is determined in S1021 that the temperature is less than the threshold Th, S1022 process is performed.

In S1022 of FIG. 6, the control unit 21 of the delivery support device 20 sorts the article P1 into the first group G1.

On the other hand, in the present embodiment, it is assumed that the article P2 has a thermal t2 of 5° C. In S1021, the control unit 21 determines that the thermal t2 of the article P2 is equal to or greater than the threshold Th. If it is determined in S1021 that the temperature is equal to or higher than the threshold Th, S1023 process is performed.

In S1023 of FIG. 6, the control unit 21 of the delivery support device 20 sorts the article P2 into a second group G2 different from the first group G1.

In S1024 of FIG. 6, the control unit 21 of the delivery support device 20 determines the delivery order of the entire one or more articles. Specifically, the items sorted in the first group G1 are assigned an order earlier than the items sorted in the second group G2. In the present embodiment, the article P1 is sorted into a first group, and the article P2 is sorted into a second group. The control unit 21 assigns an order earlier than the article P2 to the article P1.

In this manner, the control unit 21 of the delivery support device 20 compares the temperature indicated by the acquired temperature data D1 with the threshold Th for each of the one or more articles, sorts the articles determined to have the temperature less than the threshold Th among the one or more articles into the first group G1, and sorts the articles determined to have the temperature equal to or higher than the threshold Th into the second group G2. The control unit 21 adjusts the delivery order by assigning the items sorted in the first group G1 to an order earlier than the items sorted in the second group G2. In the present embodiment, the control unit 21 adjusts the delivery order by assigning the first order to the article P1 and the second order later than the first order to the article P2.

It is assumed that a plurality of article P1i to P1n are sorted into the first group G1 as a result of S1021 and S1022 process of FIG. 6 being performed on one or more articles. In this case, the control unit 21 of the delivery support device 20 may determine the order between the plurality of article P1i to P1n sorted into the first group G1 prior to S1024. The order may be determined by any procedure. For example, the control unit 21 may determine the order by arranging the article P1i to P1n in descending order of temperature. The same applies to cases where S1021 and S1023 of FIG. 6 are performed on one or more articles, and thus a plurality of article P2i to P2n are sorted into the second group G2. Ordering in order of higher temperature is generally considered that higher temperature tends to cause more deterioration in quality and needs to be delivered faster.

In S103 of FIG. 5, the control unit 21 of the delivery support device 20 determines the operation route of the second vehicle 30 according to the delivery order adjusted by S102. In the present embodiment, the article P1 is assigned a first order, and the article P2 is assigned a second order later than the first order. Therefore, the control unit 21 determines the operation route so that the article P1 and the article P2 are delivered in the order of the article P1 and the article P2 by the second vehicle 30 as the operation route of the second vehicle 30.

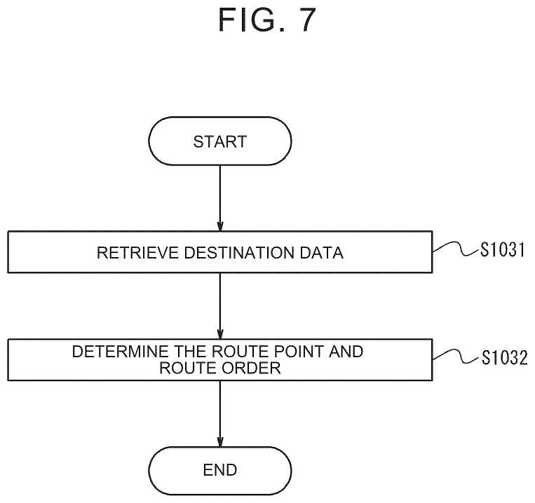

Referring to FIG. 7, a process of determining an operation route in S103 of FIG. 5 will be described.

In S1031 of FIG. 7, the control unit 21 of the delivery support device 20 acquires, for each of the one or more articles, destination-data D2 indicating a destination registered in advance for each article. The destination is, for example, an address of a name addressee for each article. Specifically, the control unit 21 acquires information indicating the house 132, which is a destination registered in advance for the article P1, and the house 111, which is a destination registered in advance for the article P2, as destination data D2. The destination data D2 may be acquired by any procedure, but in the present embodiment, it is acquired by the following procedure.

The article P1 or article P2 is brought by the sender to the carrier's brokerage store and received by the brokerage store clerk. The store clerk of the intermediary store that has received the article P1 or the article P2 inputs the address designated by the sender of the article P1 or the article P2 into the intermediary store terminal device installed in the intermediary store, for example, as part of the procedure of receiving the article P1 or the article P2. The brokerage shop terminal device transmits information indicating the inputted destination to the delivery support device 20 as a destination data D2. The control unit 21 of the delivery support device 20 receives the destination data D2 transmitted from the brokerage shop terminal device via the communication unit 23. The control unit 21 stores the received destination data D2 in the storage unit 22. In this way, the control unit 21 of the delivery support device 20 acquires the destination data D2.

As a modification of the present embodiment, the destination data D2 may be written in advance in an information-storage medium attached to the respective articles. The information-storage medium is, for example, an electronic tag, an integrated circuit (IC) tag, or a radio frequency (RF) tag. In the present embodiment, the second vehicle 30 may read the destination data D2 written in the information storage medium by the input unit 34 and transmit the read destination data D2 from the second vehicle 30 to the delivery support device 20 via the communication unit 33. The control unit 21 of the delivery support device 20 receives the destination data D2 transmitted from the second vehicles 30 via the communication unit 23, and stores the received destination data D2 in the storage unit 22. In this way, the control unit 21 of the delivery support device 20 may acquire the destination data D2.

In S1032 of FIG. 7, the control unit 21 of the delivery support device 20 determines the route and the route order of the second vehicles 30. Specifically, the control unit 21 of the delivery support device 20 refers to the delivery order adjusted in S102 of FIG. 5. Specifically, the control unit 21 refers to the delivery order in which the article P1 is in the first order and the article P2 is in the second order. Then, the control unit 21 refers to the destination data D2 acquired in S1031 of FIG. 7, and sets the house 132, which is the destination registered for the article P1 whose delivery order is the first order, as the first destination, and sets the house 111, which is the destination registered for the article P2 whose delivery order is the second order, as the second destination. The control unit 21 determines, as an operation route of the second vehicle 30, a route that passes through the house 132 that is the first passing place and the house 111 that is the second passing place in this order. In this way, the control unit 21 of the delivery support device 20 determines, as the operation route of the second vehicle 30, a route that reaches the first point, which is the destination registered for the articles sorted into the first group, and reaches the second point, which is the destination registered for the articles sorted into the second group. In this way, the control unit 21 of the delivery support device 20 determines the operation route of the second vehicle 30 according to the delivery order adjusted by S102.

In S104 of FIG. 5, the control unit 21 of the delivery support device 20 notifies the second vehicle 30 of the operation route data D3 indicating the operation route. Specifically, the control unit 21 transmits the operation route data D3 indicating the operation route determined by S103 to the second vehicle 30 via the communication unit 23. The second vehicle 30 receives the operation route data D3 transmitted from the delivery support device 20 via the communication unit 33. The control unit 31 of the second vehicle performs control to cause the second vehicle 30 to travel in accordance with the operation route indicated by the operation route data D3. That is, the second vehicles 30 deliver the article P1 and the article P2 in the order of the house 132 that is the destination of the article P1 and the house 111 that is the destination of the article P2.

As described above, in the present embodiment, the control unit 21 of the delivery support device 20 acquires temperature data D1 indicating the temperature of each article for each of the one or more articles. The control unit 21 adjusts the delivery order of the one or more articles in accordance with the temperature indicated by the acquired temperature data D1.

For example, an article requiring temperature control, such as a frozen food, may deteriorate in quality due to an increase in temperature during delivery. According to the present embodiment, it is possible to determine that an article whose temperature is equal to or lower than the threshold Th is the preferential delivery target, and to direct the second vehicle 30 to the destination of the article determined to be the preferential delivery target, rather than the destination of the other article. Therefore, items requiring temperature control are quickly delivered to the addressee. As a result, deterioration of the quality of the article during transportation is suppressed.

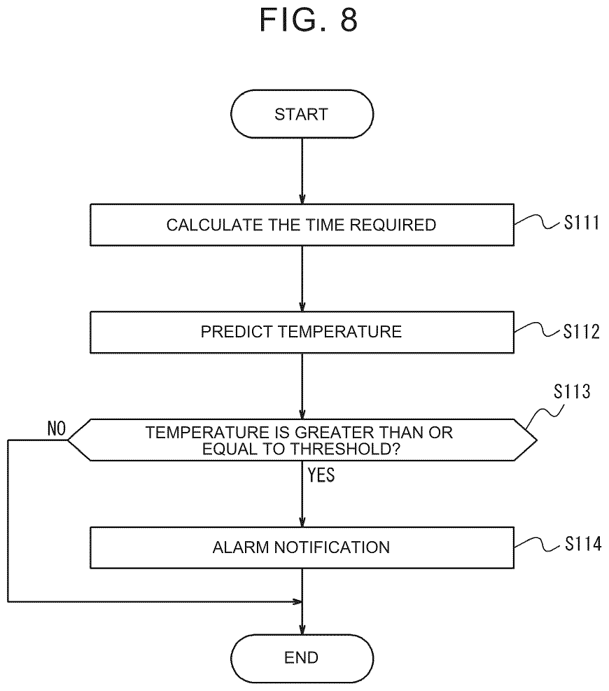

Another operation of the delivery support device 20 according to the present embodiment will be described with reference to FIG. 8. This operation also corresponds to the delivery support method according to the present embodiment.

In S111 of FIG. 8, the control unit 21 of the delivery support device 20 calculates the required time to the first point of the second vehicle 30 in the operation route determined in S103 of FIG. 5. Specifically, the control unit 21 acquires the travel information of the second vehicle 30, and calculates the required time to the first point of the second vehicle 30 on the determined travel route based on the acquired travel information. In the present embodiment, the travel information is information indicating the position and speed of the second vehicle 30. In the present embodiment, the first point is the house 132 that is the first via point.

The travel information may be acquired by an arbitrary procedure, but is acquired by, for example, the following procedure. The control unit 31 of the second vehicle 30 acquires information indicating the position measured by the positioning unit 36. The position is indicated by, for example, two-dimensional coordinates or three-dimensional coordinates. Furthermore, the control unit 31 of the second vehicle 30 acquires information indicating the speed measured by a sensor such as an acceleration sensor attached to the second vehicle 30. The control unit 21 of the delivery support device 20 acquires the information indicating the position and the speed indicated by the acquired information as the travel information of the second vehicle 30.

The control unit 21 of the delivery support device 20 calculates the required time to the first point of the second vehicle 30 on the determined travel route based on the acquired travel information. As an example, it is assumed that the distance from the position of the second vehicle 30 indicated by the traveling information to the first point is 100 meters, and the speed of the second vehicle 30 indicated by the traveling information is 10 meters per minute. In this case, the control unit 21 calculates the required time to the first point of the second vehicle 30 as 10 minutes.

In S112, the control unit 21 of the delivery support device 20 predicts the temperature of the articles sorted into the first group after the elapse of the required time calculated by S111. Specifically, the control unit 21 predicts the temperature of the article P1 after 10 minutes. The temperature of the article may be predicted by any procedure, but in this embodiment is predicted by the following procedure. The control unit 21 acquires the surrounding information of the second vehicle 30. In the present embodiment, the neighborhood information is information indicating the temperature of the neighborhood of the second vehicle 30. The peripheral information may be acquired by an arbitrary procedure, for example, the following procedure. The control unit 31 of the second vehicle 30 acquires information indicating the temperature around the second vehicle 30 measured by the temperature sensor TS2 as the input unit 34. The control unit 31 of the second vehicle 30 transmits the acquired information to the delivery support device 20 via the communication unit 33. The control unit 21 of the delivery support device 20 receives the information transmitted from the second vehicle 30 via the communication unit 23. The control unit 21 of the delivery support device 20 acquires the information indicating the temperature indicated by the received information as the surrounding information of the second vehicle 30. The control unit 21 predicts the temperature of the article P1 after the calculated required time elapses based on the temperature indicated by the acquired surrounding information and the required time calculated by S111. As an example, it is assumed that the temperature indicated by the ambient information is 25° C., and the temperature rise per minute of the article P1 when the temperature is 25° C. is 1° C. The control unit 21 of the delivery support device 20 predicts the temperature of the article P1 after the elapse of the required time as −10° C. when the temperature t1 of the article P1 is −20° C. and the required time calculated by S111 is 10 minutes.

In S113, the control unit 21 of the delivery support device 20 compares the temperature predicted by S112 with the threshold Th. Specifically, the control unit 21 determines whether or not the temperature predicted by S112 is equal to or higher than the threshold Th. When it is determined that the temperature predicted by S112 is greater than or equal to the temperature, S114 process is performed. On the other hand, when it is determined that the predicted temperature is less than the threshold Th, the process of FIG. 8 ends. In the above example, the article P1 is predicted to be at −10° C. in S112. In the present embodiment, since the threshold Th is −15° C., the control unit 21 determines that the temperature predicted by S112 is equal to or higher than the threshold Th.

In S114, the control unit 21 of the delivery support device 20 notifies the user of an alarm. Specifically, the control unit 21 generates, as an alarm, a message for notifying a sign of quality degradation of an article, and outputs the generated message. For example, the control unit 21 generates a message indicating that there is a possibility of degradation of the article P1 as an alarm. As an example, the control unit 21 says, “The package addressed to you is being transported. It may cause quality degradation due to temperature rise. A message is generated. The control unit 21 transmits the generated message to the terminal device 50 of the user via the communication unit 23. Specifically, the control unit 21 transmits the generated message to the terminal device 50 of the user who is the addressee of the article P1 via the communication unit 23. The control unit 21 may transmit, together with the generated message, information indicating the position indicated by the travel information acquired from the second vehicle 30.

As described above, the control unit 21 of the delivery support device 20 acquires the travel information indicating the position or the speed of the second vehicle 30, and calculates the required time to the first point of the second vehicle 30 on the determined travel route based on the acquired travel information. The control unit 21 acquires surrounding information indicating the ambient temperature around the second vehicle 30, and predicts the temperature of the article sorted into the first group after the calculated required time elapses on the basis of the acquired surrounding information and the calculated required time. The control unit 21 compares the predicted temperature with the threshold Th, and notifies the user of an alert when it is determined that the predicted temperature is equal to or higher than the threshold Th.

For example, in a case where the number of articles is large and delivery takes time, or in a case where the temperature of the article is high and the temperature of the article rises in a short time, such as in summer, it may be difficult to deliver the article to the addressee before the temperature of the article rises beyond the limit deemed necessary to prevent quality deterioration in transportation. In the present embodiment, even in such a case, it is possible to notify the user of an alarm in advance. The user who has been notified of the warning can take a countermeasure for suppressing degradation of the article P1, for example, by himself/herself going to the second vehicle 30 and receiving the article P1. Therefore, deterioration in quality of the article during transportation is further suppressed.

As a modification of the present embodiment, a flag may be set in advance in an article requiring temperature control. The control unit 21 of the delivery support device may adjust the delivery order by sorting the items having the flag set among the one or more articles into the first group G1 and sorting the items having the flag not set in the second group G2.

As a further modification of the present modification, the control unit 21 of the delivery support device 20 may compare the temperature indicated by the temperature data D1 with the threshold Th with respect to the article with the flag, and output an alarm when the temperature is equal to or higher than the threshold Th. According to the present modification, it is possible to detect an abnormal temperature rise that can lead to degradation of the quality of the article when the temperature rises above a threshold Th for some reason even though the article requires temperature control. Therefore, deterioration of the quality of the article during transportation is further suppressed.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

For example, the delivery support device 20 may be provided in the first vehicle 40.

For example, the article P1 is not limited to frozen food, but may be fresh food. In this instance, the threshold Th may be a temperature range having a constant range, such as 5° C. to −5° C., or may be a temperature range including a constant error, such as around 0° C.

In the following, some of the embodiments of the present disclosure will be illustrated. However, it should be noted that embodiment of the present disclosure is not limited to these.

### APPENDIX 1

A delivery support device for supporting delivery of one or more articles, comprising: A delivery support device comprising: a control unit that acquires temperature data indicating a temperature of each article for each of the one or more articles, and adjusts a delivery order of the one or more articles according to the temperature indicated by the acquired temperature data.

### APPENDIX 2

For each of the one or more articles, the control unit compares the temperature indicated by the acquired temperature data with a threshold value, and sorts the article determined to be less than the threshold value among the one or more articles into a 1 group, and sorts the article determined to be equal to or higher than the threshold value into a 2 group different from the 1 group. The delivery support device according to claim 1, wherein the delivery order is adjusted by assigning an order earlier than an article sorted into the 2 group to an article sorted into the 1 group.

### APPENDIX 3

A delivery process for delivering one or more articles includes a first delivery process from when one or more articles are mounted on a first vehicle to be transported by a first vehicle to an intermediate delivery point and delivered from a first vehicle to a second vehicle separate from the first vehicle at an intermediate delivery point, and a second delivery process from when one or more articles are delivered to a second vehicle to be transported by a second vehicle to a respective destination of one or more articles and delivered to a respective addressee of one or more articles.

The delivery support device according to Appendix 1 or 2, wherein the control unit determines an operation route of the second vehicle according to the adjusted delivery order.

### APPENDIX 4

The control unit acquires, for each of the one or more articles, destination data indicating a destination registered in advance for each article,

The delivery support device according to any one of Appendices 1 to 3, wherein the control unit refers to the acquired destination data and determines, as an operation route of the second vehicle, a route that reaches the first point, which is a destination registered for the article sorted into the first group, and reaches the second point, which is a destination registered for the article sorted into the second group, as an operation route of the second vehicle.

### APPENDIX 5

The second vehicle is provided with a temperature sensor for detecting the temperature of each of the one or more articles delivered from the first vehicle.

The delivery support device further includes a communication unit that communicates with the second vehicle.

The delivery support device according to any one of Appendices 1 to 4, wherein the control unit receives, via the communication unit, data transmitted from the second vehicle and indicating a value detected by the temperature sensor, and acquires the received data as temperature data.

### APPENDIX 6

The control unit acquires travel information indicating a position or a speed of the second vehicle, and calculates a required time to the first point of the second vehicle on the determined travel route based on the acquired travel information.

The control unit acquires peripheral information indicating an air temperature around the second vehicle, and predicts a temperature of the article sorted into the 1 group after the calculated required time elapses based on the acquired peripheral information and the calculated required time.

The delivery support device according to any one of Appendices 1 to 5, wherein the control unit compares the predicted temperature with a threshold value, and notifies the user of an alarm when it is determined that the predicted temperature is equal to or higher than the threshold value.

### APPENDIX 7

The delivery support device according to any one of Appendices 1 to 6, wherein the control unit generates a message for notifying an indication of quality degradation of an article as an alarm, and outputs the generated message.

### APPENDIX 8

A communication unit configured to communicate with a terminal device held by a user, The delivery support device according to any one of Appendices 1 to 7, wherein the control unit transmits information indicating an alarm to the terminal device via the communication unit.

### APPENDIX 9

A communication unit for communicating with the first vehicle,

The delivery support device according to any one of Appendices 1 to 8, wherein the control unit receives, via the communication unit, data indicating the temperature of each article transmitted from the first vehicle for each of the one or more articles as temperature data.

### APPENDIX 10

The delivery support device according to any one of Appendices 1 to 9,

With the second vehicle

A system comprising:

### APPENDIX 11

The delivery support device according to any one of Appendices 1 to 9,

With the terminal device

A system comprising:

### APPENDIX 12

The delivery support device according to any one of Appendices 1 to 9,

With the first vehicle

A system comprising:

### APPENDIX 13

A delivery support method for supporting delivery of one or more articles, comprising:

A control unit acquires temperature data indicating a temperature of each article for each of one or more articles, and adjusts a delivery order of one or more articles according to a temperature indicated by the acquired temperature data

A delivery support method including:

### APPENDIX 14

The delivery support method of claim 13, wherein the adjusting includes, by the control unit, comparing the temperature indicated by the acquired temperature data with a threshold value for each of the one or more articles, sorting the one or more articles determined to have a temperature less than the threshold value into a first group, sorting the one or more articles determined to have a temperature greater than or equal to the threshold value into a second group separate from the first group, and assigning the one or more articles sorted into the first group an earlier order than the one sorted into the second group.

### APPENDIX 15

A delivery process for delivering one or more articles includes a first delivery process from when one or more articles are mounted on a first vehicle to be transported by a first vehicle to an intermediate delivery point and delivered from a first vehicle to a second vehicle separate from the first vehicle at an intermediate delivery point, and a second delivery process from when one or more articles are delivered to a second vehicle to be transported by a second vehicle to a respective destination of one or more articles and delivered to a respective addressee of one or more articles.

The delivery support method according to Appendix 13 or 14, further comprising determining, by the control unit, an operation route of the second vehicle according to the adjusted delivery order.

### APPENDIX 16

The method further includes obtaining, by the control unit, for each of the one or more articles, destination data indicating a pre-registered destination for each article. The delivery support method according to any one of Appendices 13 to 15, wherein determining an operation route of the second vehicle includes determining, by the control unit, a route that reaches, with reference to the acquired destination data, a first point that is a destination registered for the article sorted in the 1 group and a second point that is a destination registered for the article sorted in the 2 group, as an operation route.

### APPENDIX 17

The second vehicle is provided with a temperature sensor for detecting the temperature of each of the one or more articles delivered from the first vehicle.

The delivery support method according to any one of Appendices 13 to 16, wherein acquiring the temperature data includes: receiving, by the communication unit, data indicating a value detected by the temperature sensor transmitted by the second vehicle; and acquiring, by the control unit, the data received by the communication unit.

### APPENDIX 18

The control unit acquires travel information indicating a position or a speed of the second vehicle, and calculates a required time to the first point of the second vehicle on the determined travel route based on the acquired travel information.

The control unit acquires peripheral information indicating an air temperature around the second vehicle, and predicts the temperature of the article sorted into the first group after the calculated required time elapses based on the acquired peripheral information and the calculated required time.

The control unit compares the predicted temperature with a threshold value, and when it is determined that the predicted temperature is equal to or higher than the threshold value, notifies the user of an alarm

The delivery support method according to any one of Appendices 13 to 17, further comprising:

### APPENDIX 19

The delivery support method according to any one of Appendices 13 to 18, wherein the notification of the pre-alarm includes generating, by the control unit, a message for notifying an indication of deterioration in quality of the article as an alarm, and outputting the generated message.

### APPENDIX 20

The delivery support method according to any one of Appendices 13 to 19, wherein the notification of the alarm includes transmitting the information indicating the alarm to the terminal device held by the user by the communication unit.

The present disclosure is not limited to the embodiment described above. For example, two or more blocks shown in the block diagram may be integrated, or a single block may be divided. Instead of executing two or more steps shown in the flowchart in chronological order according to the description, the steps may be executed in parallel or in a different order, depending on the processing capacities of the devices that execute the steps, or as necessary. Other changes may be made without departing from the scope of the present disclosure.

What is claimed is:

1. A delivery support device that supports delivery of one or more articles, the delivery support device comprising
a control unit that acquires temperature data indicating a temperature per article for each of the one or more articles, and adjusts a delivery order of the one or more articles in accordance with the temperature indicated by the acquired temperature data.

2. The delivery support device according to claim 1, wherein the control unit:
compares the temperature indicated by the acquired temperature data with a threshold, for each of the one or more articles;
sorts, into a first group, an article that is determined to have a temperature less than the threshold among the one or more articles, and sorts, into a second group different from the first group, an article that is determined to have a temperature equal to or higher than the threshold; and
adjusts the delivery order by assigning an earlier order to the article sorted in the first group than the article sorted in the second group.

3. The delivery support device according to claim 2, wherein a delivery process of delivering the one or more articles includes:
a first delivery process from when the one or more articles are mounted on a first vehicle until the one or more articles are transported to an intermediate delivery point by the first vehicle and handed over from the first vehicle to a second vehicle different from the first vehicle at the intermediate delivery point; and
a second delivery process from when the one or more articles are handed over to the second vehicle until the one or more articles are transported to respective destinations of the one or more articles by the second vehicle and handed over to respective addressees of the one or more articles, and
the control unit determines an operation route of the second vehicle in accordance with the adjusted delivery order.

4. The delivery support device according to claim 3, wherein:
the control unit acquires, for each of the one or more articles, destination data indicating a destination registered in advance for each of the articles; and
the control unit refers to the acquired destination data and determines, as the operation route of the second vehicle, a route that reaches a first point earlier than a second point, the first point being a destination registered for the article sorted into the first group and the second point being a destination registered for the article sorted into the second group.

5. The delivery support device according to claim 3, wherein the second vehicle is provided with a temperature sensor that detects a temperature of each of the one or more articles handed over from the first vehicle,
the delivery support device further comprising a communication unit that communicates with the second vehicle, and
wherein the control units receives, via the communication unit, data transmitted from the second vehicle and indicating a value detected by the temperature sensor, and acquires the received data as the temperature data.

6. The delivery support device according to claim 4, wherein:
the control unit acquires travel information indicating a position or a speed of the second vehicle, and calculates a required time for the second vehicle to the first point in the determined operation route, based on the acquired travel information;
the control unit acquires peripheral information indicating an air temperature around the second vehicle, and predicts a temperature of the article sorted into the first group after the calculated required time elapses, based on the acquired peripheral information and the calculated required time; and
the control unit compares the predicted temperature with the threshold, and notifies a user of a warning when the control unit determines that the predicted temperature is equal to or higher than the threshold.

7. The delivery support device according to claim 6, wherein the control unit generates a message for performing notification of a sign of quality deterioration of the article as the warning, and outputs the generated message.

8. The delivery support device according to claim 6, further comprising a communication unit that communicates with a terminal device held by the user,
wherein the control unit transmits information indicating the warning to the terminal device via the communication unit.

9. The delivery support device according to claim 3, further comprising a communication unit that communicates with the first vehicle,
wherein the control units receives, as the temperature data, data indicating a temperature per article transmitted from the first vehicle for each of the one or more articles, via the communication unit.

10. A system comprising:
the delivery support device according to claim 3; and
the second vehicle.

11. A system comprising:
the delivery support device according to claim 8; and
the terminal device.

12. A system comprising:
the delivery support device according to claim 9; and
the first vehicle.

13. A delivery support method for supporting delivery of one or more articles, the delivery support method comprising causing a control unit to acquire temperature data indicating a temperature per article for each of the one or more articles, and to adjust a delivery order of the one or more articles in accordance with the temperature indicated by the acquired temperature data.

14. The delivery support method according to claim 13, wherein adjusting the delivery order includes causing the control unit to compare the temperature indicated by the acquired temperature data with a threshold for each of the one or more articles, sorting an article determined to have a temperature less than the threshold among the one or more articles into a first group, sorting an article determined to have a temperature equal to or higher than the threshold into a second group different from the first group, and assigning an earlier order to the article sorted into the first group than the article sorted into the second group.

15. The delivery support method according to claim 14, wherein a delivery process of delivering the one or more articles includes:
a first delivery process from when the one or more articles are mounted on a first vehicle until the one or more articles are transported by the first vehicle to an intermediate delivery point and handed over to a second vehicle different from the first vehicle at the intermediate delivery point;
a second delivery process from when the one or more articles are handed over to the second vehicle until the one or more articles are transported by the second vehicle to respective destinations of the one or more articles and handed over to respective addressees of the one or more articles; and
causing the control unit to determine an operation route of the second vehicle in accordance with the adjusted delivery order.

16. The delivery support method according to claim 15, further comprising causing the control unit to acquire, for each of the one or more articles, destination data indicating a destination registered in advance for each of the articles,
wherein determining the operation route of the second vehicle includes causing the control unit to refer to the acquired destination data and determine, as the operation route, a route that reaches a first point earlier than a second point, the first point being a destination registered for the article sorted into the first group and the second point being a destination registered for the article sorted into the second group.

17. The delivery support method according to claim 15, wherein the second vehicle is provided with a temperature sensor that detects a temperature of each of the one or more articles handed over from the first vehicle, and
wherein acquiring the temperature data includes:
causing a communication unit to receive data indicating a value detected by the temperature sensor and transmitted from the second vehicle; and
causing the control unit to acquire the data received by the communication unit.

18. The delivery support method according to claim 16, further comprising:
causing the control unit to acquire travel information indicating a position or a speed of the second vehicle, and calculate a required time for the second vehicle to the first point in the determined operation route, based on the acquired travel information;
causing the control unit to acquire peripheral information indicating an air temperature around the second vehicle, and predict a temperature of the article sorted into the first group after the calculated required time elapses, based on the acquired peripheral information and the calculated required time; and
causing the control unit to compare the predicted temperature with the threshold, and notify a user of a warning when the control unit determines that the predicted temperature is equal to or higher than the threshold.

19. The delivery support method according to claim 18, wherein performing notification of the warning includes causing the control unit to generate a message for performing notification of a sign of quality deterioration of the article as the warning, and output the generated message.

20. The delivery support method according to claim 18, wherein performing notification of the warning includes causing a communication unit to transmit information indicating the warning to a terminal device held by the user.
